(19) United States
(12) Patent Application Publication
(10) Pub. No.: US 2005/0201792 A1
(43) Pub. Date: Sep. 15, 2005

(54) Image forming apparatus having foldable paper cassette

(76) Inventors: Sang-cheol Park, Suwon-si (KR); Young-min Kim, Suwon-si (KR)

Correspondence Address: STANZIONE & KIM, LLP, 1740 N STREET, N.W., FIRST FLOOR, WASHINGTON, DC, 20036, US

(21) Appl. No.: 10/961,152

(22) Filed: Oct. 12, 2004

(30) Foreign Application Priority Data
Mar. 15, 2004 (KR) 2004-17440

(51) Int. Cl. G03G 15/00

(52) U.S. Cl. 399/393

(57) ABSTRACT

An image forming apparatus including a main body, an image forming part provided within the main body so as to form an image on a recording medium; and a recording medium cassette detachably coupled to the main body so as to load the recording medium to be fed to the image forming part, wherein the recording medium cassette has a hinge part that makes the recording medium cassette foldable to a certain size.

### CROSS-REFERENCE TO RELATED APPLICATIONS

This application claims the benefit of Korean Patent Application No. 2004-17440, filed Mar. 15, 2004, the disclosure of which is hereby incorporated herein by reference in its entirety.

### BACKGROUND OF THE INVENTION

1. Field of the Invention

The present general inventive concept relates to an image forming apparatus and, more particularly, to an image forming apparatus having a foldable paper cassette.

2. Description of the Related Art

Recently, with rapid development of industrial technologies, various kinds of electronic equipment are newly developed and produced. The equipment has been progressively better in performance and also smaller and more compact in size. Particularly, an image forming apparatus mainly used in an office or at home, as a type of electronic equipment, is being designed much smaller and more compact to reduce space required at the office or at home.

Accordingly, components constituting the image forming apparatus, for example, a main body and an image forming part formed thereto, are modified and manufactured in a minimal size and an optimal structure capable of forming an image on paper.

In manufacturing the image forming apparatus, it is comparatively difficult to make a paper feeder part for feeding paper into the main body smaller due to a basic size of paper, although the other parts may be comparatively modified and manufactured in a minimal size and an optimal structure.

Specifically, A4 size paper (297×210 mm) is used as a basic paper in many of the offices or homes. Although such parts as a main body, an image forming part and so on may be reduced in size, it is in fact difficult to make the paper feeder part smaller due to a basic size of A4 paper.

Thus, there recently have been proposed various methods for reduction and modification in the size of the paper feeder part in an attempt to make the image forming apparatus smaller and more compact.

Meanwhile, the conventional paper feeder part comprises a paper tray for manually feeding a few sheets of paper and a paper cassette for automatically feeding many sheets of paper. Accordingly, the methods for reduction and modification in the size of the paper feeder part have been proposed, which are divided into a method for the paper tray and a method for the paper cassette.

First, as for the paper tray, the paper tray is rotated through certain angles from the main body of the image forming apparatus such that the paper may be selectively fed manually only when required to feed the paper. Such a paper tray is disclosed in Japan Patent Publication Nos. 1996-104449 (publication date: Apr. 23, 1996; title: PAPER FEEDER) and 1995-144768 (publication date: Jun. 6, 1995; title: SHEET FEEDER AND IMAGE FORMING DEVICE). Thus, although paper includes an A4 size, the image forming apparatus may achieve a smaller and more compact size because the paper tray is formed to be rotated at a certain angle from the main body of the image forming apparatus.

Also, as for the paper cassette, the paper cassette is formed such that it may be selectively assembled only when required to automatically feed paper and, otherwise, it may be disassembled into two parts when not required to feed paper, or when required to move the image forming apparatus. Thus, although paper has a basic size like A4 size, the image forming apparatus may achieve a smaller and compact size because the paper tray is formed in a disassembled/assembled form.

However, since such a conventional paper cassette as described above is formed in a disassembled/assembled form according to whether the paper is being fed, and according to whether the image forming apparatus is being conveyed, there is a problem in having to disassemble/assemble the paper cassette whenever paper is being fed or whenever the image forming apparatus is being moved.

Also, the conventional paper cassette is disassembled into two parts when it is not required to feed the paper or when the image forming apparatus needs to be moved, so that it may cause a problem in that the disassembled paper cassette has to be separately stored or managed in order to preventlosing the paper cassette.

### SUMMARY OF THE INVENTION

Accordingly, it is an aspect of the present general inventive concept to provide an image forming apparatus in which a recording medium cassette thereof is provided in a smaller size and is prevented in advance from having to be stored or managed to prevent losing it.

It is another aspect of the present general inventive concept to provide an image forming apparatus having a recording medium cassette which is foldable so that it is formed in a smaller size without having to be disassembled.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing an image forming apparatus including a main body, an image forming part provided with the main body so as to form an image on a recording medium, and a recording medium cassette detachably coupled to the main body so as to load the recording medium to be fed to the image forming part, wherein the recording medium cassette has a hinge part that makes the recording medium cassette foldable to a certain size.

In an aspect of the general inventive concept, the recording medium cassette may be formed so that a part thereof extends external to the main body to be exposed through the main body when coupled to the main body, and the hinge part may be formed at a portion of the recording medium cassette and exposed external to the main body.

In another aspect of the general inventive concept, the recording medium cassette exposed external to the main body may have a fixing protrusion that is fixed to the main body when the recording medium cassette is folded.

In another aspect of the general inventive concept, the main body may have a fixing groove into which the fixing protrusion is inserted when the recording medium cassette is folded.

In another aspect of the general inventive concept, the hinge part may be formed at a portion of the recording medium cassette exposed external to the main body and near the main body.

In another aspect of the general inventive concept, a recording medium length adjustment unit may be provided at an upper portion of the recording medium cassette so as to guide the recording medium loaded in the recording medium cassette according to a length thereof.

In another aspect of the general inventive concept, the recording medium length adjustment unit may be formed on the recording medium cassette such that the recording medium length adjustment unit is reciprocated from an end of the recording medium cassette exposed external to the main body to a portion of the recording medium cassette positioned inside the main body so as to be moved inside the main body when the recording medium cassette is folded.

In another aspect of the general inventive concept, the recording medium length adjustment unit may have a guide rail longitudinally formed on the upper portion of the recording medium cassette and a recording medium length adjustment guide sliding on the guide rail and formed to be foldable.

### BRIEF DESCRIPTION OF THE DRAWINGS

The above and other features and advantages of the present general inventive concept will become more apparent to those of ordinary skill in the art by describing in detail preferred embodiments thereof with reference to the attached drawings of which:

FIG. 1 shows a schematic perspective view of an image forming apparatus according to an embodiment of the present general inventive concept;

FIG. 2 shows a perspective view of the image forming apparatus of FIG. 1, which illustrates a state in which a recording medium cassette has been rotated at a certain angle;

FIG. 3 shows a cross-sectional view taken along the line A-A of FIG. 2; and

FIG. 4 shows a cross-sectional view of an image forming apparatus according to another embodiment of the present general inventive concept.

### DETAILED DESCRIPTION OF THE PREFERRED EMBODIMENTS

The present general inventive concept will now be described more fully hereinafter with reference to the accompanying drawings, in which preferred embodiments are shown. This general inventive concept may, however, be embodied in different forms and should not be construed as limited to the embodiments set forth herein. Rather, these embodiments are provided so that this disclosure will be thorough and complete, and will fully convey the scope of the general inventive concept to those skilled in the art. Like numbers refer to like elements throughout the specification.

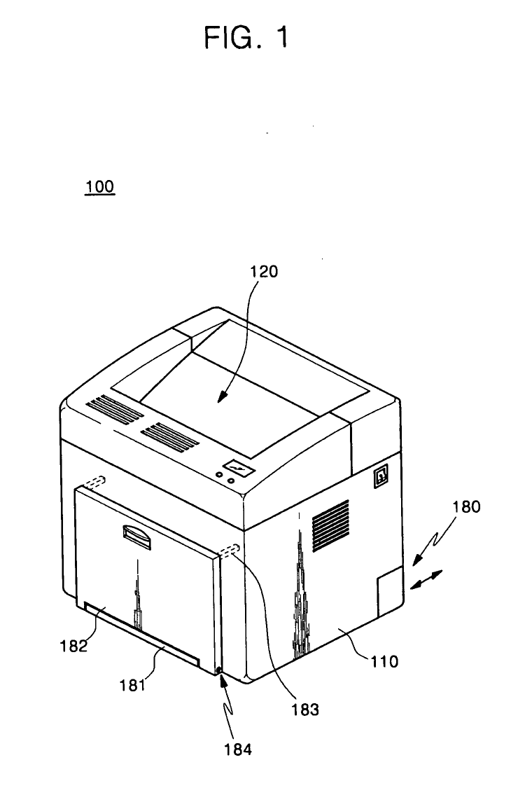

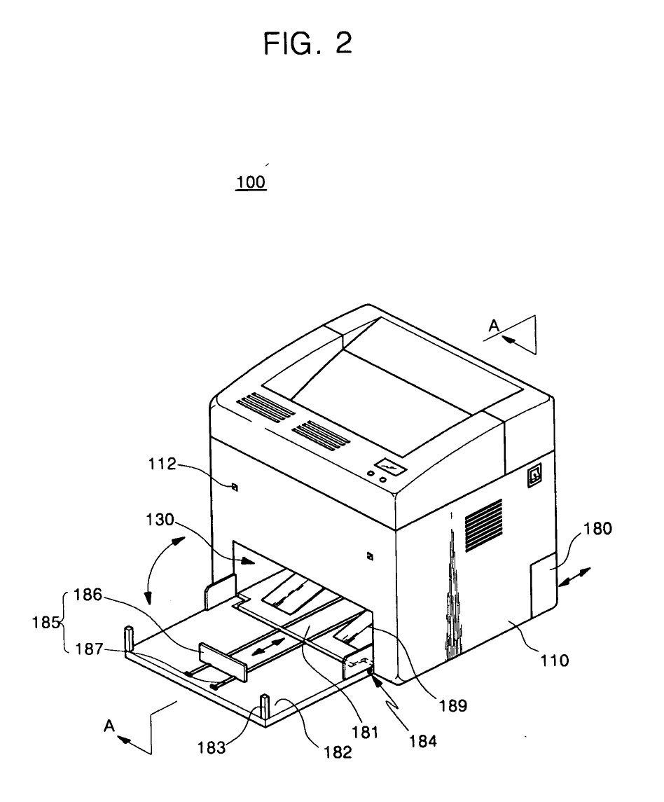

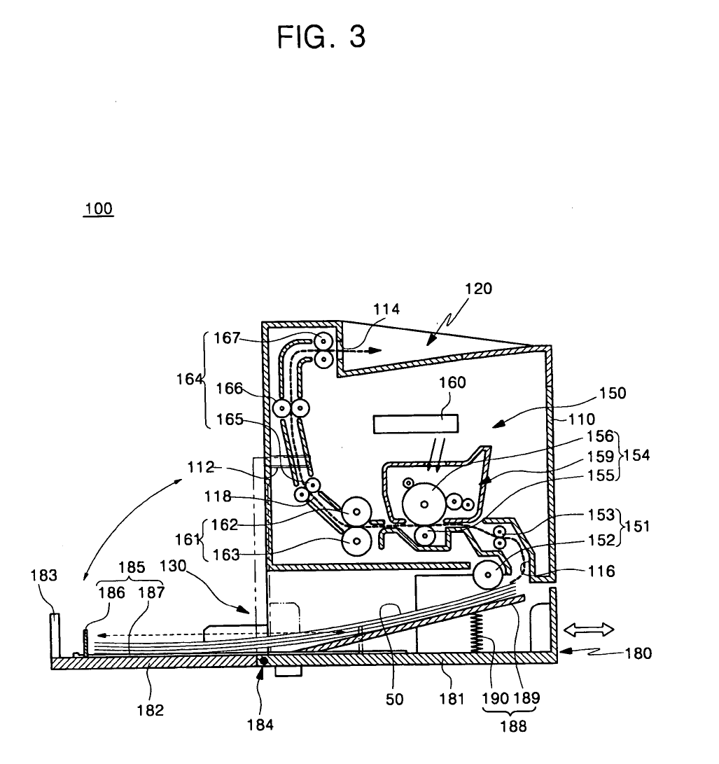

First, referring to FIGS. 1 to 3, an image forming apparatus 100 of the present general inventive concept may include a main body 110 forming a contour, a recording medium (i.e., paper or the like) feeder part 130 provided at a lower position of the main body 110 so as to feed the recording medium to the main body, an image forming part 150 provided in the main body 110 so as to form an image on the feeding recording medium, a recording medium discharge part 120 provided on the main body 110 so as to recording medium 50 having an image formed thereon, and a central control part (not shown) that generally controls the image forming apparatus 100.

More particularly, the main body 110 may have a box shape, which is provided with a recording medium conveying path 118 therein. The main body 110 is provided not only with a recording medium inlet 116 at a lower portion thereof, to which a recording medium 50 is fed from the recording medium feeder part 130, but also with a recording medium outlet 114 at a upper portion thereof, through which the recording medium 50 fed inside the main body 110 is discharged to the recording medium discharge part 120. Also, a fixing groove 112 is formed at a surface of an outer portion of the main body 110 into which a fixing protrusion 183, to be described later, may be inserted.

The recording medium feeder part 130 serves to feed the recording medium 50 to the main body 110 and slides on the main body 110 to be detachably coupled to the main body 110, thereby being formed as a recording medium cassette 180 formed in a drawer shape to load many sheets of the recording medium 50.

Specifically, when coupled to the main body 110, the recording medium cassette 180 is formed to partially pass through the main body 110 and can be exposed external to the main body 110 by a certain length. The recording medium cassette 180 can include a hinge part 184 allowing the paper cassette 180 to be folded to a certain size, a fixing protrusion 183 that fixes a portion of the folded recording medium cassette 180 to the main body 110, a recording medium length adjustment unit 185 that guides the recording medium 50 which is loaded in the recording medium cassette 180, and a recording medium knock-up unit 188 that knocks-up the recording medium 50 which is loaded in the recording medium cassette 180 by a certain height so that a pick-up roller 152, to be described later, picks up the knocked-up recording medium 50. Herein, the recording medium cassette 180 is formed to pass through the main body 110 and is exposed external to the main body 110 by a certain length, since, as described above, although parts of the image forming apparatus 100 such as the main body 110, the image forming part 150 and so on may be formed in a smaller and more compact size according to a development tendency of electronic equipment, it is difficult to additionally reduce the recording medium cassette 180 feeding the recording medium 50 inside the main body 110 due to a basic size of A4 paper that is often used as the recording medium 50.

Next, as for the hinge part 184, it is an aspect of the general inventive concept to make the recording medium cassette 180 foldable and formed at a portion of the recording medium cassette 180 exposed external to the main body 110 when the recording medium cassette 180 is exposed externally through the main body 110. In other words, the hinge part 184 may be formed at a portion of the recording medium cassette 180 exposed external to the main body 110 and near the main body 110. More specifically, under the assumption that a portion fixed inside the main body 110 is referred to as a fixed member 181 and a portion exposed externally through the main body 110 is referred to as an exposed member 182 when the paper cassette 180 is coupled to the main body 110, the hinge part 184 may be formed at a portion of the exposed member 182 near the fixed member 181 so as to fold the members 181 and 182 relative to each other. Accordingly, when feeding of the recording medium 50 is required, the user can merely feed the recording medium 50 after rotating the exposed member 182 parallel to the fixed member 181 and extending serially therefrom.

Further, the fixing protrusion 183 can serve to fix a portion of the folded recording medium cassette 180 to the main body 110 so that it is formed at a portion of the exposed member 182 that is exposed externally through the main body 110 when the recording medium cassette 180 is coupled to the main body 110. In an aspect of the general inventive concept, the fixing protrusion 183 may be formed at an end corner of the exposed member 182. Also, the fixing groove 112 formed at one surface of the main body 110 and into which the fixing protrusion 183 can be inserted may be formed to correspond with the fixing protrusion 183 when the paper cassette 180 is folded.

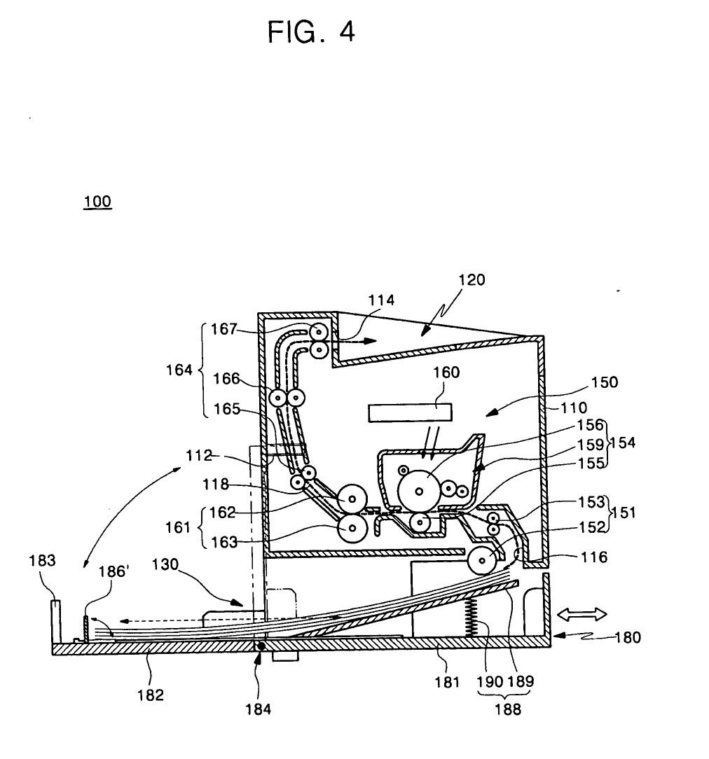

Also, the recording medium length adjustment unit 185 serves to guide the recording medium 50 loaded in the recording medium cassette 180 according to the length of the recording medium 50. The recording medium length adjustment unit 185 may have a guide rail 187 longitudinally formed on an upper portion of the recording medium cassette 180 and a recording medium length adjustment guide 186 reciprocatingly sliding on the guide rail 187. Herein, the guide rail 187 may extend from an end of the exposed member 182 exposed external to the main body 110 to a portion of the fixed member 181 positioned inside the main body 110. Accordingly, when the user tries to fold the recording medium cassette 180 in a state that it is fixed to the main body 110, the user can move the recording medium length adjustment guide 186 inside the main body 110 along the guide rail 187 and then fold the recording medium cassette 180. Herein, as shown in FIG. 4, a recording medium length adjustment guide 186′ can be formed to be foldable. In this case, when a user tries to fold the recording medium cassette 180 in a state that it is fixed to the main body 110, as described above, the user can first fold only the recording medium length adjustment guide 186′ to a certain angle without moving the same inside the main body 110, and then fold the recording medium cassette 180.

Also, the recording medium knock-up unit 188 can serve to knock-up the recording medium 50 loaded in the recording medium cassette 180, and may include a supporting stand 189 formed as a flat panel to support the recording medium 50 and a spring 190 provided under the supporting stand 189 to support the same in the upper direction at a lower portion thereof.

Meanwhile, the image forming part 150 may include a recording medium feed unit 151 that feeds the paper 50 loaded in the recording medium cassette 180 inside the main body 110, a transfer unit 154 that transfers an image on the recording medium 50 fed by the recording medium feed unit 151, an exposure unit 160 that applies a certain laser beam to the transfer unit 154 such that the transfer unit 154 transfers the image to the recording medium 50, a fixing unit 161 for semi-permanently fixing the image transferred on the recording medium 50 by the transfer unit 154, and a recording medium discharge unit 164 that discharges the image-fixed recording medium 50 to the paper outlet 114.

Specifically, the recording medium feed unit 151 has a pick-up roller 152 that picks-up the recording medium 50 loaded in the recording medium cassette 180 and conveys the same inside the main body 110, a double-feed prevention means (not shown) that prevents a double feed of the recording medium 50 picked-up by the pick-up roller 152, and a feed roller 153 that feeds the picked-up and conveyed recording medium 50 toward the transfer unit 154.

The transfer unit 154 may have a photosensitive drum 156 on which an electrostatic latent image is formed by the laser beam applied from the exposure unit 160, a developer 159 that transforms the electrostatic latent image formed on the photosensitive drum 156 into a visible image using a toner, and a transfer roller 155 that transfers the developed visible image on the recording medium 50.

The exposure unit 160 serves to apply a certain laser beam to the photosensitive drum 156 to form the electrostatic latent image according to control of the central control unit, and may be formed as a laser scanning unit.

The fixing unit 161 may have a heating roller 162 that applies heat to the recording medium 50 to fix the transferred image, and a press roller 163 mounted to the heating roller 162 to be roll-contacted to apply pressure to the recording medium 50.

The recording medium discharge unit 164 serves to convey the image-fixed recording medium 50 along the paper conveying path 118 and then to discharge the same to the recording medium outlet 114. The paper discharge unit 164 may be formed as a plurality of rollers 165, 166 and 167.

Finally, the recording medium discharge part 120 may be provided at an upper portion of the main body 110 to load the recording medium 50 discharged to the recording medium outlet 114 such that it is slanted at a certain angle. Thus, the recording medium 50 discharged to the recording medium discharge part 120 can be automatically self-aligned in one direction due to a slant of the recording medium discharge part 120.

Hereinafter, an operation and an effect of the image forming apparatus 100 according to the present general inventive concept are described in detail as follows.

First, as described above, since the image forming apparatus 100 of the present general inventive concept includes the foldable recording medium cassette 180, it can be conveyed and stored in a state as shown in FIG. 1, in which the recording medium cassette 180 is folded at a certain angle and is fixed to the main body 110 when it is being moved or when it is not being used.

Then, when an image forming operation is required, a portion of the recording medium cassette 180 fixed to the main body 110 can be rotated downward. Thus, a portion of the recording medium cassette 180 positioned inside the main body 110, that is, the fixed member 181, and a portion exposed external to the main body 110, that is, the exposed member 182, can be arranged serially to each other and parallel with each other.

Then, when the recording medium cassette 180 has been rotated, the user can draw and slide the paper cassette 180 outside the main body 110 by a certain distance, and then can load some sheets of the recording medium 50 in the recording medium cassette 180.

Then, after the recording medium 50 has been loaded, the user can push the recording medium cassette 180 back inside the main body 110, and thus the recording medium cassette 180 can be mounted to the main body 110.

Then, when the recording medium cassette 180 has been mounted, the user can transfer a signal from a host computer (not shown) to the image forming apparatus 100 to perform the image forming operation.

Accordingly, the recording medium 50 loaded in the recording medium cassette 180 is fed one by one to the transfer unit 154 by the recording medium feed unit 151 of the image forming part 150, and the transfer unit 154 transfers a certain image on the recording medium fed one by one according to the certain laser beam applied from the exposure unit 160.

Then, the image-transferred recording medium 50 passes through the fixing unit 161 by which heat and pressure are simultaneously applied to the image transferred recording medium 50 so that it is possible to semi-permanently fix the certain image on the recording medium 50.

Then, the image-fixed recording medium 50 is moved at a constant distance along the recording medium conveying path 118 by the recording medium discharge unit 164 including a plurality of rollers 165, 166 and 167, and is then discharged to the recording medium outlet 114. Thus, the sheets of the image-formed recording medium 50 are loaded one after another to the recording medium discharge part 120 provided outside the recording medium outlet 114.

Meanwhile, when the image forming operation has been completed, the user may reduce a size of the image forming apparatus 100 again to reduce the required space of the office or the home in which the image forming apparatus 100 is used. In this case, the user can pull out the loaded recording medium 50 from the recording medium cassette 180 and then can fold a portion of the recording medium cassette 180 again to fix the same to the main body 110. Herein, since the recording medium length adjustment guide 186 is caught by the main body 110 upon folding of the recording medium cassette 180, the recording medium length adjustment guide 186 itself can be folded, and then the paper cassette 180 can be folded, otherwise, the recording medium length adjustment guide 186 can be moved inside the main body 110 and then the recording medium cassette 180 can be folded. Accordingly, the user may perform an image forming operation using a smaller and more compact image forming apparatus 100 while maximizing the efficiency of the space within the office or home.

As described before, the image forming apparatus of the present general inventive concept has an advantage in that it can be stored in a state that the recording medium cassette is folded after performing an image forming operation so that a mounting area of the image forming apparatus is minimized and a space of the office or the home is maximized, because the image forming apparatus has the foldable recording medium cassette.

There is also provided an advantage in that the foldable recording medium cassette makes the size of the image forming apparatus smaller because the recording medium cassette, which conventionally prevents compactness of the image forming apparatus, is foldable.

There is further provided an advantage in that a possibility of loss of the recording medium cassette is minimized since the recording medium cassette of the image forming apparatus is not disassembled/assembled, but is folded instead.

There is still further provided an advantage in that the recording medium cassette can be conveniently used through a simple rotation upon an operation of image forming because the recording medium cassette of the image forming apparatus is not a disassembled/assembled type, but a foldable type.

There is still further provided an advantage in that a whole size of the image forming apparatus is reduced and movement thereof is also convenient because the image forming apparatus has the foldable paper cassette, thus accomplishing a scale-down version of the apparatus.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An image forming apparatus comprising:
a main body;
an image forming part provided within the main body that forms an image on a recording medium; and
a recording medium cassette detachably coupled to the main body to load the recording medium to be fed to the image forming part, the recording medium cassette having a hinge part that makes the recording medium cassette foldable to a certain size.

2. The image forming apparatus as claimed in claim 1, wherein the recording medium cassette is formed so that a part thereof extends externally through the main body when coupled to the main body and the hinge part is formed at a portion of the recording medium cassette exposed external to the main body.

3. The image forming apparatus as claimed in claim 2, wherein the recording medium cassette exposed external to the main body has a fixing protrusion that fixes to the main body when the recording medium cassette is folded.

4. The image forming apparatus as claimed in claim 3, wherein the main body has a fixing groove into which the fixing protrusion is inserted when the recording medium cassette is folded.

5. The image forming apparatus as claimed in claim 2, wherein the hinge part is formed at a portion of the recording medium cassette exposed external to the main body and near the main body.

6. The image forming apparatus as claimed in claim 2, wherein a recording medium length adjustment unit is provided at an upper portion of the recording medium cassette to guide the recording medium loaded in the recording medium cassette according to a length thereof.

7. The image forming apparatus as claimed in claim 6, wherein the recording medium length adjustment unit is formed on the paper cassette and reciprocates from an end of the recording medium cassette exposed external to the main body to a portion of the recording medium cassette positioned inside the main body to be moved inside the main body when the recording medium cassette is folded.

8. The image forming apparatus as claimed in claim 6, wherein the recording medium length adjustment unit has a guide rail longitudinally formed on the upper portion of the paper cassette and a recording medium length adjustment guide that slides on the guide rail and is formed to be foldable.

9. The image forming apparatus as claimed in claim 1, wherein the recording medium cassette comprises:
a first portion which is exposed externally to the main body; and
a second portion which is fixed within the main body, such that the hinge part connects the first portion and the second portion to be foldable with respect to each other.

10. The image forming apparatus as claimed in claim 9, further comprising:
a recording medium length adjusting unit that is slidable along an upper surface of the first portion of the recording medium cassette when extended away from the main body at the hinge part to be parallel with the second portion of the recoding medium cassette, such that recording medium length adjusting unit is slidable to a length of different size recording mediums.

11. The image forming apparatus as claimed in claim 10, wherein the recording medium length adjusting unit is foldable towards an outer surface of the main body when slidably extended outside of the main body.

12. The image forming apparatus as claimed in claim 11, wherein the first portion of the recording medium cassette folds toward the main body to cover the recording medium length adjusting unit when the recording medium length adjusting unit is folded toward the outer surface of the main body.

13. An image forming apparatus including an image forming unit that forms an image on recording mediums of different lengths, comprising:
a main body; and
a cassette detachably coupled to the main body to feed the recording medium to the image forming unit, the cassette including a first end extending external to the main body and being foldable within a side of the main body.

14. The image forming apparatus as claimed in claim 13, further comprising:
a fixing groove formed within the side of the main body; and
a fixing protrusion extending from the first end of the cassette and being insertable into the fixing groove when the first end of the cassette is folded within the side of the main body.

15. The image forming apparatus as claimed in claim 13, further comprising:
a recording medium length adjusting unit slidable into and out of the main body along an upper surface of the first end of the cassette to adjust to the recording mediums of different lengths placed thereon, and to slide within the main body when the first end of the cassette is being folded toward the main body.

16. The image forming apparatus as claimed in claim 13, further comprising:
a recording medium length adjusting unit slidable into and out of the main body along an upper surface of the first end of the cassette to adjust to the recording mediums of different lengths placed thereon, and to be foldable toward the main body when the first end of the cassette is being folded toward the main body.

17. An image forming apparatus including an image forming unit that forms an image on recording mediums of different lengths, comprising:
a main body; and
a cassette detachable from the main body and including:
an exposed member exposed externally to the main body;
a fixed member fixed within the main body; and
a hinge member that connects a first end of the exposed member and a first end of the fixed member such that the exposed member is foldable with respect to the first end of the fixed member toward the main body.

18. The image forming apparatus as claimed in claim 17, further comprising:
a fixing groove formed within the side of the main body; and
a fixing protrusion extending from the exposed member of the cassette and being insertable into the fixing groove when the exposed member is folded toward the main body.

19. The image forming apparatus as claimed in claim 17, further comprising:
a recording medium length adjusting unit slidable into and out of the main body along an upper surface of the exposed portion of the cassette to adjust to the recording mediums of different lengths placed thereon, and to slide within the main body when the exposed portion of the cassette is being folded toward the main body.

20. The image forming apparatus as claimed in claim 17, further comprising:
a recording medium length adjusting unit slidable into and out of the main body along an upper surface of the exposed portion of the cassette to adjust to the recording mediums of different lengths placed thereon, and to be foldable toward the main body when the exposed portion of the cassette is being folded toward the main body.
